(19) United States
(12) Patent Application Publication
(10) Pub. No.: US 2005/0206721 A1
(43) Pub. Date: Sep. 22, 2005

(54) Method and apparatus for disseminating information associated with an active conference participant to other conference participants

(76) Inventors: Dennis Bushmitch, Somerset, NJ (US); Alan Kaplan, Princeton, NJ (US); Wanrong Lin, Plainsboro, NJ (US)

Correspondence Address: RATNERPRESTIA, P O BOX 980, VALLEY FORGE, PA, 19482-0980, US

(21) Appl. No.: 10/805,904

(22) Filed: Mar. 22, 2004

(51) Int. Cl. H04N 7/14; H04M 3/42; G06F 15/16

(52) U.S. Cl. 348/14.09; 709/204

(57) ABSTRACT

A method and apparatus is disclosed for disseminating information associated with an active conference participant in a conference call to conference participants. Information is disseminated by associating the conference participants with participant information, identifying an active conference participant supplying data to a conference bridge for broadcast to the other conference participants, and transmitting at least a portion of the participant information associated with the active conference participant over a data network to the conference participants substantially concurrent with the broadcast of the data by the conference bridge.

### FIELD OF THE INVENTION

The present invention relates to the field of communications and, more particularly, to methods and apparatus for disseminating information associated with an active conference participant to other conference participants through instant messaging.

### BACKGROUND OF THE INVENTION

A teleconference is a conference held among people in different locations using telecommunications equipment, such as telephones or video conferencing terminals. Audio and, sometimes, video supplied by each participant on the conference is communicated to every other participant on the conference to enable communications among the conference participants. The equipment that enables communications among the conference participants is a bridge or a switch, which broadcast data received from each conference participant to all other conference participants.

In audio only conferences it is sometimes difficult to identify the active conference participant (e.g., a speaking participant) currently providing data to a bridge for broadcast to the other conference participants. In addition, it may be difficult to determine information (e.g., contact information) associated with the active conference participant in video conferences if the conference participants are unfamiliar with one another. Furthermore, existing conference systems do not employ a mechanism for recording the words and/or actions of active conference participants and attributing those words and/or actions to the appropriate conference participant (e.g., for non-repudiation). Thus, conference participants may not be held accountable for their statements and/or actions.

Present conference systems are an important tool for use in business. Not being able to readily identify active conference participants and the potential for conference participants to repudiate their words and/or actions, however, decreases the acceptance and usefulness of this business tool. Accordingly, conference systems that are not subject to these limitation are needed. The present invention fulfils this need among others.

### SUMMARY OF THE INVENTION

The present invention is embodied in a method and apparatus for disseminating information associated with an active conference participant to conference participants of a conference through instant messaging. Information is disseminated by associating the conference participants with participant information, identifying an active conference participant supplying data to a conference bridge for broadcast to the other conference participants, and transmitting at least a portion of the participant information associated with the active conference participant over a data network to the conference participants substantially concurrent with the broadcast of the data by the conference bridge.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Included in the drawings are the following figures:

FIG. 1 is a block diagram of an exemplary enhanced conference system in accordance with the present invention;

FIG. 1A is a block diagram of exemplary functions performed by a conference enhancement system of the exemplary enhanced conference system of FIG. 1;

FIGS. 2A, 2B, and 2C illustrate various exemplary participant location arrangements for use in the exemplary enhanced conference system of FIG. 1; and

FIG. 3 is a flow chart of exemplary steps for identifying an active participant in a conference call to other conference call participants.

### DETAILED DESCRIPTION OF THE INVENTION

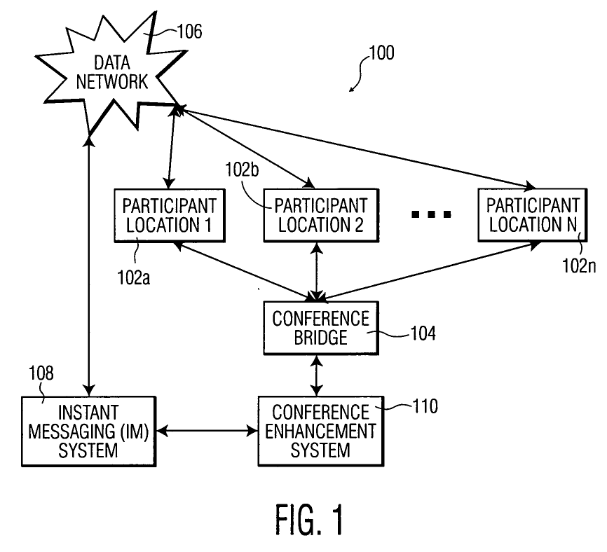

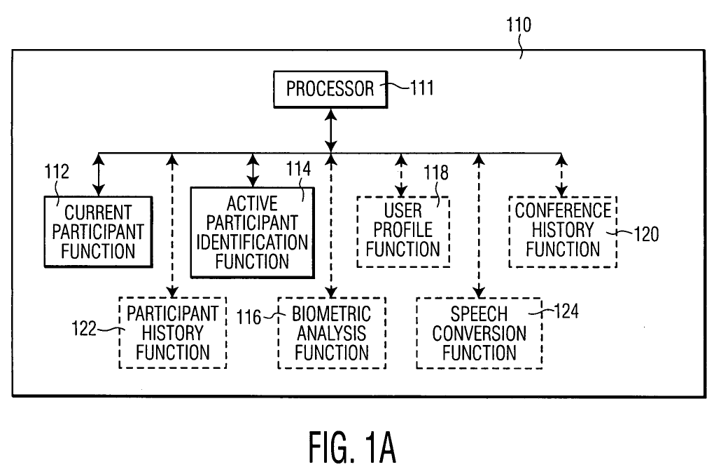

FIG. 1 depicts an exemplary enhanced conference system 100 for enabling a conference among two or more participant locations 102a-n, each participant location having one or more conference participants. In general overview, conference participants at the participant locations 102 access a conference bridge 104, which broadcasts audio and/or video data from each participant location 102 to conference participants at other participant locations 102. In addition, the conference participants access a data network 106 that provides access to an instant messaging (IM) system 108. A conference enhancement system 110 associates conference participants accessing the conference bridge 104 with participant information for use with the IM system 108. When a conference participant supplies data to the conference bridge 104 for broadcast at a particular time (i.e., an active conference participant), the conference enhancement system 110 identifies the active conference participant and supplies at least a portion of the participant information associated with the active conference participant (e.g., name, company information, etc.) to the other conference participants via the IM system 108 over the data network 106 substantially concurrent with the broadcast of the data at the particular time by the conference bridge 104. Thus, the identity of the active conference participant can be revealed to the other conference participants. Exemplary embodiments of the present invention are now described in detail.

The participant locations 102 exchange data with the conference bridge 104 and the IM system 108. The participant locations 102 may exchange data with the conference bridge 104 using conventional telecommunication connection lines and the participant locations 102 may exchange data with the IM system 108 via the data network 106. In an exemplary embodiment, the participant locations 102 are configured to exchange audio and/or video signals with the conference bridge 104 and to exchange text, audio, and/or video messages with the IM system 108. The participant locations 102 may be in different buildings or within the same building, room, or general vicinity.

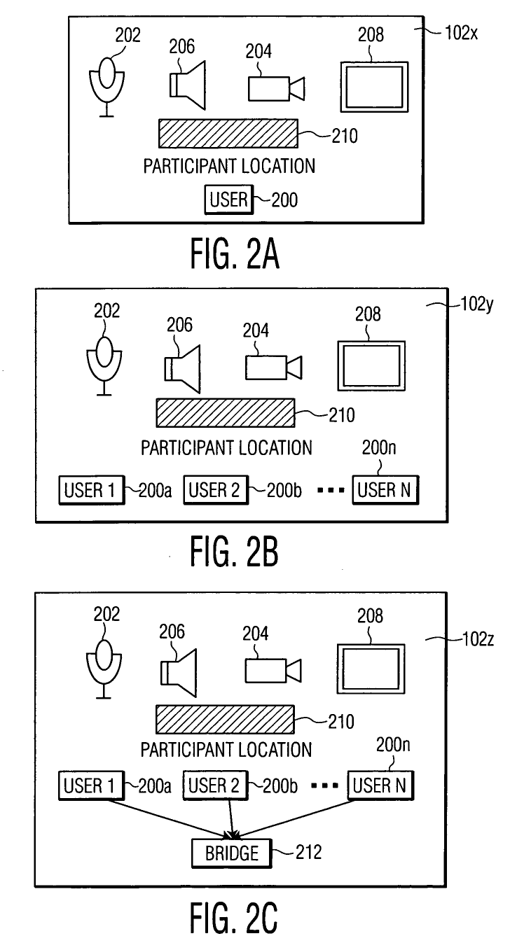

FIG. 2A depicts an exemplary participant location 102x. The exemplary participant location 102x includes a user (i.e., conference participant) 200. In addition, the participant location 102x may include one or more of a microphone 202 for developing audio data, a video camera 204 for developing video data, a speaker 206 for presenting audio data, a video display 208 for presenting video data, and a keyboard 210 for developing textual data. Other input/output (I/O) devices may also be employed. Suitable I/O devices for use with the present invention will be understood by those of skill in the art.

FIG. 2B depicts an alternative exemplary participant location 102y that is similar to the exemplary participant location 102x depicted in FIG. 2A with the exception that multiple users 200a-n are located at the participant location 102y. Each user may have their own microphone 202, video camera 204, speaker 206, video display 208, and/or keyboard 210, or multiple users may share one or more of these I/O devices. FIG. 2C depicts an alternative exemplary participant location 102z that is similar to the exemplary participant location 102y depicted in FIG. 2B with the exception that the participant location 102z includes a bridge 212 through which the users 200 access the conference bridge 104 (FIG. 1). The bridge 212 may convert audio/video signals into a format compatible with the conference bridge 104 (e.g., a data format). Suitable bridges for use in the participant locations 102 will be understood by those of skill in the art.

Referring back to FIG. 1, the conference bridge 104 is configured to transfer audio and/or video signals among the participant locations 102 attached to the conference bridge 104. In addition, the conference bridge 104 is configured to exchange data with the conference enhancement system 110. The conference bridge 104 may be configured for use with plain old telephone service (POTS), integrate services digital network (ISDN), voice over IP (VOIP), video conferencing, H.323 video standards, H.261 audio standards, or essentially any standard for communicating audio and/or video signals. The selection and modification of a suitable conference bridge for use with the conference enhancement system 110 will be understood by those of skill in the art from the description herein.

The data network 106 provides a link between the participant locations 102 and the IM system 108. The data network 106 may be a global information network (e.g., the Internet) or other network such as an intranet, local area network (LAN), or wide area network (WAN). Although a single data network is depicted, multiple data networks (not shown) may be employed to establish connections with the participant locations 102.

The IM system 108 is configured to deliver textual, aural, and/or visual communications from the conference enhancement system 110 to the participant locations 102 via the data network 106 or the conference bridge 104. In addition, the IM system 108 may be configured to deliver information received from the participant locations 102 to the conference enhancement system 110 and to other conference participants.

The conference enhancement system 110 coordinates the identification of active conference participants and performs other system functions. As described in further detail below, the conference enhancement system receives participant information from the participant locations 102 via the conference bridge 104 and/or the data network 106 and associates the conference participants with the participant information. In an exemplary embodiment, the conference enhancement system 110 resides on a server that supports an IM protocol. Thus, the conference enhancement system 110 and the IM system 108 may reside on a common server, or on different servers.

In an exemplary embodiment, the participant information includes personal information and location information. The personal information may include, by way of non-limiting example, a formal name, “friendly” name, company name, phone numbers, e-mail addresses, and other such information. The location information may include a uniform resource locator (URL) for contacting the conference participant over the data network 106 such as a Session Initiation Protocol (SIP) URL, e.g., “SIP:ParticipantName@companyname.com.” A SIP URL is essentially a portable network ID that is network location independent. As described in further detail below, the participant information may be supplied using the IM system 108 and/or the conference bridge 104. Alternatively, a website (not shown) corresponding to the conference bridge 104 may be used to receive participant information.

FIG. 1A depicts functions that may be performed by a processor 111 within the conference enhancement system 110. These functions include, by way of non-limiting example (with core functions indicated in solid line boxes and other functions indicated in dashed line boxes): a current participant function 112, a participant identification function 114, a biometric analysis function 116, a user profile function 118, a conference history function 120, a participant history function 122, and a voice recognition function 124. The processor 111 may be one or more processors configured to perform the functions of the conference enhancement system. Suitable processors for use with the present invention will be understood by those of skill in the art from the description herein.

The current participant function 112 is a function performed by the conference enhancement system 110 to track conference participants 102 that are currently accessing the conference bridge 104. The current participant function 112 may be embodied in a database residing on a server, e.g., the server on which the conference enhancement system 110 resides. The current participant function 112 may track conference participants 102 by adding at least a portion of their participant information to the database when they access and subscribe to the conference bridge 104 and deleting and/or moving their information to a conference history database (see discussion of conference history function 118 below) when they disconnect from the conference bridge 104. Suitable signaling between the conference bridge 104 and the conference enhancement system 110 to update the list of current participants will be understood by those of skill in the art.

In an exemplary embodiment, the current participant function 112 tracks the conference participants 200 (FIG. 2A-2C) by participant location 102 based on a port identifier associated with the port of the conference bridge 104 through which the participant location 102 accessed the conference bridge 104. In this embodiment, each conference participant 200 from a particular participant location 102 is associated with a particular port identifier. In an alternative exemplary embodiment, the current participant function 112 tracks the individual conference participants 200 from each participant location 102. For example, if multiple parties in a conference room access the conference bridge 104 through a speaker phone having a microphone 202 (FIG. 2) and a speaker 206 (FIG. 2), or through another bridge 212 (FIG. 2C), the current participant function 112 may include all conference participants 200 at that particular participant location 102 or that access the conference bridge 104 from the other bridge 212. In accordance with this embodiment, the current participant function 112 may include an aural and/or visual biometric signature associated with each conference participant 200 in order to identify different participants on a single port, such as in FIG. 2B. The aural and/or visual biometric signature may be included within the participant information or may be separate.

Conference participants 200 (FIGS. 2A-2C) may supply their participant information via the IM system 108 and/or the conference bridge 104 if the conference bridge has instant message connectivity. Alternatively, conference participants 200 may go to an enhanced conference system website (not shown) coupled to the conference enhancement system 110 and enter the participant information into input fields of the website. Functionality to provide information to the website may be incorporated into a communication software product such as commonly used Internet browsers and IM communication applications. For example, conference participants may supply their Internet browser with their friendly name and SIP URL once and the Internet browser automatically supplies this information every time the conference participant visits an enhanced conference system website. In addition, conference participants may supply a unique conference identifier provided to them by the conference enhancement system 110 when they access the conference bridge in order to facilitate the association of the conference participant with the participant information.

The active participant identification function 114 is a function performed by the conference enhancement system 110 to identify active conference participants. In an exemplary embodiment, where there is one conference participant for each participant location 102, the participant identification function 114 identifies the active conference participant based on the port identifier of the conference bridge 104, which may be supplied by the conference bridge 104 when data is received at a port. For example, the participant identification function 114 may compare the port identifier of the conference bridge 104 to the port identifier associated with the participant location 102, e.g., by the current participant function 112.

In an alternative exemplary embodiment, the active participant identification function 114 identifies active conference participants based on an analysis of aural and/or visual biometric characteristics using the biometric recognition function 116. The biometric recognition function 116 is a function performed by the conference enhancement system 110 to analyze aural and/or visual biometric characteristics associated with conference participants to identify active conference participants. For example, using the biometric identification function 116, the participant identification function 114 may compare a sample of aural and/or visual data, passed from the conference bridge 104 to the conference enhancement system 110, to the biometric signatures associated with the conference participants by the current participant function 112.

The biometric analysis function 116 may analyze aural biometric characteristics by comparing an aural data sample received through the conference bridge 104 to an aural signature stored by the current participant function 112. For example, distribution of intensity peaks and associated frequencies of the aural data sample may be compared to distribution of intensity peaks and associate frequencies of the stored aural signatures to identify a match. If a match is found, the biometric analysis function 116 passes the identity of the matched conference participant to the participant identification functions 114 that, in turn, identifies this conference participant as the active conference participant to the conference enhancement system 110. Suitable aural biometric analysis techniques will be understood by those of skill in the art.

Visual biometric characteristics may be analyzed by comparing a visual data sample received through the conference bridge 104 to a visual signature stored by the current participant function 112. For example, a ratio of the distance between the eyes of a conference participant to the distance from the eyes to the nose of the visual data sample may be compared to ratios of stored visual signatures to identify a match. If a match is found, the biometric analysis function 116 passes the identity of the matched conference participant to the participant identification functions 114 that, in turn, identifies this conference participant as the active conference participant to the conference enhancement system 110. Suitable visual biometric analysis techniques will be understood by those of skill in the art.

In an exemplary embodiment, the biometric analysis function 116 may also use a port identifier supplied by the conference bridge 104 to narrow the number of current conference participants that are active participant candidates, in order to enhance the recognition of the biometric data. For example, assume two ports of the conference bridge are in use with five conference participants accessing the conference bridge through a first port and five other conference participants accessing the conference bridge though a second port. In this example, limiting the candidates for the active participant to a particular port receiving data from the conference participants, e.g., the first port, reduces the number of possible candidates to be identified per port using biometric signatures (i.e., from ten to five), thereby increasing the probability of a successful conference participant identification using the biometric data.

The user profile function 118 is a function performed by the conference enhancement system 110 to maintain profiles for conference participants. For example, users may specify whether they want to turn off the IM system so that their name is not broadcast to other participants and/or other conference participant information is not presented to them. In addition, the user profile function 118 may be used to filter participant information based on the maintained profiles. For example, one set of information may be provided to one group of conference participants (e.g., conference participants in the same company as the active conference participant) and another set of information may be provided to another group of conference participants (e.g., conference participants in a company other than the company of the active conference participant). For example, title and contact information may be provided to one group and only name provided to another group. Groups may be identified based on location information such as their SIP URLs or other participant information. Settings in the user profile may be established using a website (not shown) that the conference participants access over the data network 106 prior to participating in a conference. The conference enhancement system 110 examines the user profiles to determine what information to send to which conference participants.

The conference history function 120 is a function performed by the conference enhancement system 110 to store conference history information. Data for broadcast by the conference bridge 104 may be passed to the conference history function of the conference enhancement system 110 for storage along with the identity of the active conference participant. Storing the data passed to the conference bridge along with the identity of the active conference participant, who is supplying the data, prevents active conference participants from repudiating a statement or action made during a particular conference. In addition, the conference history function 120 may be used to provide a type written transcript of a conference.

The participant history function 122 is a function performed by the conference enhancement system 110 to maintain a list of conference participants that have previously used the conference enhancement system 100. Information associated with conference participants by the current participant function 112 may be moved from a database maintained by the current participant function 112 to a database maintained by the participant history function 122. In an exemplary embodiment, conference participants supply participant information and biometric signatures during an initial conference attended by a conference participant that is hosted by the conference enhancement system 110. The participant history function 122 maintains the biometric signatures and the participant information. In subsequent conferences, the conference participants may simply states their name and/or look into a video camera to generate biometric characteristics. The participant identification function 114 then accesses the participant history function 122 to compare the generated biometric characteristics to the biometric signatures and, if a match is found, retrieve the appropriate participant information. The participant may be presented, e.g., via the IM system 108 and/or the conference bridge 110, with an option of using the information identified using the participant history function 122 or electing to supply new information.

The speech conversion function 124 is a function performed by the conference enhancement system 110 to perform actions based on aural signals and/or to generate aural signals. For example, the speech conversion function may be employed to convert speech to text to generate participant information supplied aurally by a conference participant. In an exemplary embodiment, a known speech to text conversion product may be employed by the speech conversion function 124, such as Dragon NaturallySpeaking Version V7.0, available from ScanSoft, Inc. of Peabody, Mass. USA. This function may also be used to implement an automatic note taking function to create transcripts of at least a portion of the conferences, e.g., is conjunction with the conference history function 120 for storage or distribution to conference participants. In an exemplary embodiment, the speech conversion function 124 may also convert text to speech. For example, type written text can be converted to aural speech to enable someone without speech capability to participate in a conference, e.g., via a keyboard.

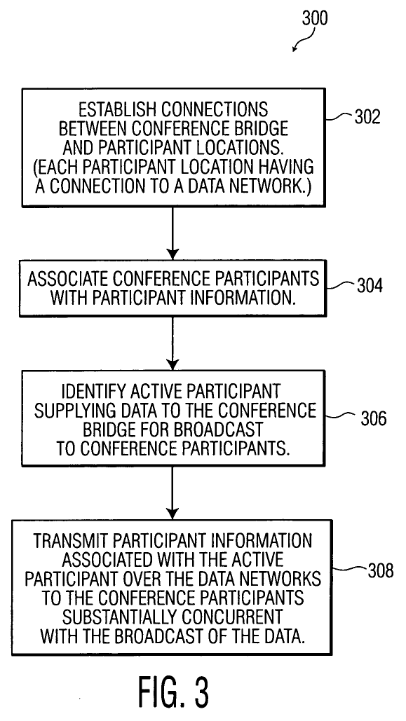

FIG. 3 is a flow chart 300 of exemplary steps (with reference to FIG. 1) for establishing a conference and disseminating information associated with active conference participants to other conference participants during the conference. At block 302, connections are established between a conference bridge 104 and the participant locations 102, where each participant location includes a connection to a data network 106.

At block 304, conference participants are associated with participant information. In an exemplary embodiment, assuming there is one conference participant at each participant location 102 (or all conference participants at a participant location 102 are to be identified by the same participant information), the conference enhancement system 110 supplies a unique conference bridge identifier to the participant location 102 when the participant location 102 accesses the conference bridge 104. A conference participant at that participant location 102 then supplies the unique conference bridge identifier and their participant information to the conference enhancement system 110 via the IM system 108 over the data network 106. Alternatively, the conference bridge identifier and the participant information may be supplied to a website (not shown) associated with the conference enhancement system 110. If there is more than one participant per participant location 102, biometric signatures (e.g., voice samples and/or visual characteristics) may also be associated with the conference participants.

In an alternative exemplary embodiment, assuming there is one conference participant at each participant location 102 (or all conference participants at a participant location 102 are to be identified by the same instant message broadcast information), the conference enhancement system 110 associates the conference participants 102 with the participant information when the conference participants access the conference enhancement system. This is done by requesting participant information from the conference participants when they access the conference bridge 104 and receiving the port identifiers associated with ports of the conference bridge 104 through which the conference participants access the conference bridge 104. If multiple conference participants are present at one or more participant locations 102, additional information such as biometric characteristics (aural and/or visual) may be supplied from the participant locations 102 to the conference enhancement system 110 via the conference bridge 104 in addition to or instead of the port identifier. The conference participants may supply the participant information by stating the information and the conference enhancement system 110 converts the statement to usable form, e.g., via a speech conversion function 124. In an alternative embodiment, the user may supply the information by using a text entry device such as a keyboard 210 (FIGS. 2A-C).

At block 306, the conference enhancement system 110 identifies the active conference participants supplying data to the conference bridge 104 for broadcast to other conference participants at a particular time. The particular time is substantially concurrent with the time at which the data is supplied to the conference bridge 104, however, delays may occur due to signal processing. In an exemplary embodiment, where there is one conference participant at each participant location 102 (or all conference participants at a participant locations 102 are to be identified by the same participant information), the conference enhancement system 110 may identify the active conference participant by determining through which port of the conference bridge 104 the conference participant is supplying data. The conference enhancement system 110 receives the port identifier from the conference bridge 104 and then identifies the active participant based on the port identifier.

In an alternative exemplary embodiment, where there are one or more conference participants at each participant location 102, at least a portion of the data for broadcast is passed from the conference bridge 104 to the conference enhancement system 110 to generate biometric characteristics. The conference enhancement system 110 then identifies the active participant by comparing the biometric characteristics to previously stored biometric signatures associated with the conference participants to identify a match. The port identifier may also be used to narrow the number of potential conference participants to only those accessing the conference bridge 104 through a particular port, thereby facilitating the identification of the active participant.

At block 308, the conference enhancement system 110 transmits at least a portion of the participant information associated with the active participant over the data networks to one or more conference participants substantially concurrent with the data broadcast at the particular time by the conference bridge identified at block 306. Delays may occur between the data broadcast by the conference bridge and the transmission of the participant information due to signal processing. In an exemplary embodiment, the conference enhancement system 110 transmits a portion of the personal information corresponding to the participant information, such as the name of the active conference participant, to conference participants by using the location information supplied by the conference participants upon accessing the conference bridge 104. The same information may be transmitted to each conference participant or the information may be selected and/or filtered based on profile information associated with the active conference participant and/or the other conference participants. In an exemplary embodiment, at least a portion of the participant information may be transmitted in response to a certain event, e.g., in response to depressing a “mute” button (not shown) on a muted telephone in anticipation of an impending communication.

In an exemplary embodiment, conference participants may additionally provide communications to the instant messaging system 108 for transmission to one or more conference participants, i.e., unicast or broadcast. For example, during a conference, a particular conference participant, e.g., an active or non-active conference participant, may supply communications via the data network 106 for delivery by the IM system 108 to one or more of the conference participants. The particular conference participant may specify delivery instructions or delivery instructions may be generated automatically based on stored profile information in the conference enhancement system.

In an exemplary embodiment, conference specific details may be provided to one or more conference participants responsive to the receipt of commands. For example, a conference administrator may issue a command to identify the number of current conference participants, e.g., by pressing a specific key combination on a touch pad or keyboard such as the pound key (#) followed by a numeral (0-9). The enhanced conference system may be configured such that the information may be selected by all conference participants or only select conference participants for distribution to all conference participants or only select conference participants. In an exemplary embodiment, the conference may also be controlled responsive to the receipt of commands (e.g., lock the conference, increase volume, etc.).

Four non-limiting exemplary scenarios are now presented for illustrative purposes with reference to FIG. 1. Many different scenarios for implementing the present invention will be understood by those of skill in the art from these scenarios and the above description.

In one exemplary embodiment, a conference participant at a participant location 102 accesses a port of the conference bridge 104 in a known manner. The conference bridge 104 passes a port identifier associated with the accessed port to the conference enhancement system 110, which generates a unique conference bridge identifier based on the port identifier. Next, the conference enhancement system 110 passes the unique conference bridge identifier to the conference participant at the participant location 102 and the conference participant supplies this unique conference bridge identifier and their participant information to the conference enhancement system 110 over the data network 106, e.g., via the IM system 108. The conference enhancement system 110 then associates the participant information (or a subset thereof) with the port identifier associated with the port through with the conference participant accessed the conference bridge 104 based on the unique conference bridge identifier.

When the conference participant supplies data to the conference bridge 104 for broadcast to other conference participants at other participant locations 102 at a particular time, the conference bridge 104 passes the port identifier of the accessed port through which the data is being supplied to the conference enhancement system 110. The conference enhancement system 110 then identifies the participant information for the active conference participant based on the port identifier and broadcasts at least a portion of the personal information within the participant information, e.g., conference participant name or “nickname,” to one or more other conference participants (e.g., using their location information) substantially concurrent with the broadcast of the data by the conference bridge.

In an alternative exemplary embodiment, each conference participant also supplies biometric signatures when they access the conference bridge 104. The conference bridge 104 passes the biometric signatures instead of the port identifier or along with the port identifier to the conference enhancement system 110. The conference enhancement system 110 generates a unique conference bridge identifier and associates the unique conference bridge identifier with the biometric signatures and, optionally, the port identifier. The conference enhancement system 110 then passes the unique conference bridge identifier to the conference participant at the participant location 102. Next, the conference participant supplies the unique conference bridge identifier and their participant information to the conference enhancement system 110 over the data network 106, e.g., via an IM system 108. The conference enhancement system 110 then associates the participant information with the biometric signatures and, optionally, the port identifier based on the unique conference bridge identifier.

When the conference participant supplies data to the conference bridge 104 for broadcast to other conference participants at other participant locations 102 at a particular time, the conference bridge 104 passes at least a portion of the data and, optionally, the port identifier associated with the port through which the data is being supplied to the conference enhancement system 110. The conference enhancement system 110 then develops biometric characteristics from the data for comparison to the previously acquired biometric signatures to identify the participant information for the active conference participant. Optionally, the port identifier may be used to limit the number of conference participant candidates in order to enhance the recognition of the biometric data by limiting the number of conference participants from which the active conference participant may be identified. The conference enhancement system then transmits information corresponding to the participant information, e.g., the conference participant's name, to other conference participants (e.g., using their location information) substantially concurrent with the broadcast of the data by the conference bridge 104.

In an alternative exemplary embodiment, a conference participant at a participant location 102 accesses a port of the conference bridge 104 in a known manner. The conference bridge 104 passes a port identifier associated with the accessed port to the conference enhancement system 110. The conference enhancement system 110 requests participant information from the conference participants via the conference bridge 104. The conference participant then supplies the participant information to the conference enhancement system 110 via the conference bridge 104 and the conference enhancement system 110 associates the participant information with the port identifier.

When the conference participant supplies data to the conference bridge 104 for broadcast to other conference participants at other participant locations 102 at a particular time, the conference bridge 104 passes to the conference enhancement system the port identifier associated with the port of the conference bridge 104 through which data is being supplied. The conference enhancement system 110 then identifies the participant information for the active conference participant based on the port identifier and transmits at least a portion of the personal information within the participant information, e.g., name, to one or more other conference participants (e.g., using their location information) substantially concurrent with the broadcast of the data by the conference bridge.

In an alternative exemplary embodiment, the conference participants also supply a biometric signature when they access the conference bridge 104. The conference bridge 104 passes this information along with the port identifier or instead of the port identifier to the conference enhancement system 110. Next, the conference participant supplies their participant information to the conference enhancement system 110 via the conference bridge 104. The conference enhancement system 110 then associates the participant information with the biometric signature and, optionally, the port identifier.

When the conference participant supplies data to the conference bridge 104 for broadcast to other conference participants at other participant locations 102 at a particular time, the conference bridge 104 passes at least a portion of the data and, optionally, the port identifier associate with the port of the conference bridge 104 through which the data is being supplied to the conference enhancement system 110. The conference enhancement system 110 then develops biometric characteristics from the data for comparison to the previously acquired biometric signatures to identify the participant information for the active conference participant. Optionally, the port identifier may be used to limit the number of conference participant candidates. The conference enhancement system 110 then transmits at least a portion of the personal information within the participant information, e.g., name, to other conference participants (e.g., using the location information within their participant information) substantially concurrent with the broadcast of the data by the conference bridge.

Although the invention is illustrated and described herein with reference to specific embodiments, the invention is not intended to be limited to the details shown. Rather, various modifications may be made in the details within the scope and range of equivalents of the claims and without departing from the invention.

1. A method for disseminating information associated with an active conference participant to conference participants in a conference system, the conference system including connections between a conference bridge and two or more participant locations, each participant location having one or more conference participants, at least one of the conference participants having a connection to a data network, the method comprising the steps of:
associating the conference participants with participant information;
identifying an active conference participant supplying data to the conference bridge for broadcast to the other conference participants; and
transmitting at least a portion of the participant information associated with the active conference participant over the data network to at least one of the conference participants having a connection to the data network substantially concurrent with the broadcast of the supplied data.

2. The method of claim 1, wherein the associating step comprises the steps of:
passing a conference bridge identifier to a new participant location, the conference bridge identifier corresponding to one or more participants at the new participant location;
receiving the conference bridge identifier and participant information corresponding to the one or more participants from the new participant location over the data network; and
associating the one or more participants from the new participant location with the participant information responsive to the received conference bridge identifier and participant information from the new participant location.

3. The method of claim 2, wherein the associating step comprises the step of:
receiving the participant information and the conference bridge identifier via a website accessible over the data network by the conference participants.

4. The method of claim 1, wherein the associating step comprises the steps of:
identifying at least one biometric characteristic of a new conference participant;
receiving participant information associated with the new conference participant from the new conference participant;
initially associating the new conference participant with the participant information based at least in part on the biometric characteristic of the conference participant and the participant information received from the conference participant and, thereafter, associating the conference participant with the participant information responsive to the biometric characteristic of the conference participant.

5. The method of claim 1, wherein the associating step comprises the steps of:
receiving the participant information from the conference participants via the conference bridge; and
associating the conference participants with the participant information received via the conference bridge.

6. The method of claim 5, wherein the conference participants are connected to ports of the bridge and wherein the step of associating the conference participants with the participant information received via the conference bridge comprises the step of:
associating the conference participants with the participant information based on the port to which each conference participant is connected.

7. The method of claim 1, wherein each conference participant accesses the conference bridge using a unique port and wherein the identifying step comprises the step of:
identifying the active participant based on the receipt of data at the port of the conference bridge accessed by the active conference participant.

8. The method of claim 1, further comprising:
receiving at least one biometric characteristic from each conference participant when establishing connections to the conference bridge;
wherein the identifying step comprises identifying the active conference participant based at least in part on the biometric characteristic.

9. The method of claim 8, further comprising the step of:
storing the at least one biometric characteristic during an initial conference for use in the identifying step during subsequent conferences.

10. The method of claim 1, further comprising:
receiving a respective aural biometric characteristic from each conference participant when establishing connections to the conference bridge; and
wherein the identifying step comprises identifying the active participant based at least in part on the respective aural biometric characteristic.

11. The method of claim 1, further comprising:
receiving a respective visual biometric characteristic from each conference participant when establishing connections to the conference bridge; and
wherein the identifying step comprises identifying the active participant based at least in part on the respective visual biometric characteristic.

12. The method of claim 1, further comprising the step of:
storing the data supplied by the identified active conference participant along with at least a portion of the participant information of the identified active conference participant.

13. The method of claim 1, further comprising the step of:
developing a profile for each of one or more conference participants; and
selecting the portion of the participant information to pass to each of the one or more conference participants responsive to their developed profiles.

14. The method of claim 1, wherein the identifying step comprises the step of:
identifying the active conference participant supplying data to the conference bridge for broadcast to the other conference participants at a particle time; and
wherein the transmitting step comprises the step of:
transmitting the participant information substantially concurrent with the broadcast of the data supplied at the particular time by the conference bridge.

15. The method of claim 1, wherein the transmitting step comprises the step of:
transmitting the at least a portion of the participant information in accordance with a Session Initiation Protocol (SIP) instant messaging (IM) system.

16. The method of claim 1, further comprising the step of:
receiving communications from a first conference participant via the data network; and
selectively distributing the communications to one or more other conference participants.

17. The method of claim 1, further comprising the steps of:
receiving one or more commands via the data network, the one or more commands associated with one or more conference specific details; and
selectively distributing information related to the one or more conference specific details to one or more conference participants responsive to the one or more commands.

18. A conferencing method in which participant information associated with active conference participants in a conference call is disseminated to conference participants, the method comprising the steps of:
establishing connections between a conference bridge and two or more participant locations, each participant location having one or more conference participants, at least one conference participant having a connection to a data network;
associating the conference participants with participant information including personal information and location information;
identifying an active conference participant supplying data to the conference bridge for broadcast to other conference participants at a particular time; and
transmitting at least a portion of the personal information associated with the active conference participant, using the location information associated with the conference participants, over the data network to one or more of the conference participants substantially concurrent with the broadcast of the data supplied at the particular time by the conference bridge.

19. The method of claim 18, wherein the associating step comprises the steps of:
identifying a respective biometric characteristic of a new conference participant;
receiving the participant information from the new conference participant;
initially associating the new conference participant with the participant information based at least in part on the respective biometric characteristic of the conference participant and the participant information received from the participant and, thereafter, associating the conference participant with the participant information responsive to the respective biometric characteristic of the conference participant.

20. The method of claim 18, further comprising:
receiving the respective biometric characteristic from each conference participant when establishing connections to the conference bridge;
wherein the identifying step comprises identifying the active participant based at least in part on the respective biometric characteristic.

21. The method of claim 20, further comprising the step of:
storing the respective biometric characteristic during an initial conference for use in the identifying step during subsequent conferences.

22. The method of claim 18, further comprising the step of:
developing a profile for each of one or more conference participants; and
selecting the portion of the participant information to pass to each of the one or more conference participants based at least in part on their developed profiles.

23. A conference apparatus for disseminating information associated with an active conference participant to conference participants in a conference system, at least one conference participant having a data connection to a data network, the apparatus comprising:
a conference bridge configured to broadcast data from an active conference participant to other conference participants;
an instant message system configured for communication with the at least one conference participant having a data connection over the data network; and
a conference enhancement system configured for use with the instant message system and the conference bridge, the conference enhancement system configured to associate one or more of the conference participants with participant information; identify an active participant supplying data to the conference bridge for broadcast to the other conference participants; and transmit at least a portion of the participant information associated with the active conference participant over the data network to one or more of the conference participants substantially concurrent with the broadcast of the data.

24. The apparatus of claim 23, wherein the conference enhancement system is configured to identify the active conference participant based on biometric characteristics associated with the active conference participant.

25. The apparatus of claim 23, wherein the conference enhancement system is configured to identify the active conference participant based on a port identifier associated with a port of the conference bridge through which the active conference participant supplies data to the conference bridge.

26. The apparatus of claim 23, wherein the conference enhancement system is configured to maintain a user profile for one or more conference participants for use when transmitting the at least a portion of the participant information to conference participants.

27. The apparatus of claim 23, wherein the conference enhancement system is configured to maintain a database of data broadcast from the conference bridge and participant information associated with the active conference participant.

28. The apparatus of claim 23, wherein the conference enhancement system is configured to maintain a database of instant message broadcast information for prior conference participants and associated biometric information for use in subsequent conferences.

29. The apparatus of claim 23, wherein the instant message (IM) system is a session initiation protocol (SIP) IM system.
